(19) United States
(12) Patent Application Publication
(10) Pub. No.: US 2012/0121763 A1
(43) Pub. Date: May 17, 2012

(54) PULP FOOD PRODUCT, PROCESS AND METHOD OF MANUFACTURING SAME

(76) Inventors: Marni Markell Hurwitz, Far Hills, NJ (US); Evan Bruce Fleischmann, West Milford, NJ (US)

(21) Appl. No.: 12/944,967

(22) Filed: Nov. 12, 2010

(51) Int. Cl. A23L 1/212; A23L 1/304; A23B 7/00; A23B 7/024; A23L 1/05; A23L 1/302

(52) U.S. Cl. 426/72; 426/615; 426/104; 426/102; 426/465; 426/385

(57) ABSTRACT

A pulp food product, process and method of manufacturing same is provided comprising at least one pulp material formed from at least one raw vegetable or fruit wherein juice is substantially removed therefrom leaving behind the pulp material. The pulp material is dried to contain no more than about 5% moisture after treatment by way of dehydration or freeze drying. In one embodiment the pulp food product comprises a base vegetable, between about 55-100% by weight, a color vegetable, between about 0-20% by weight, a flavor vegetable and/or fruit between about 0-20% by weight, and additional flavor ingredients between about 0-5% by weight. The process provides for processing raw fruits and/or vegetables through an extractor to substantially separate juice and pulp, mixing the pulp, shaping the pulp into structures, including granules, chips, sticks etc., and drying the shape pulp to no more than 5% by weight of moisture. The pulp food product composition can include flavor enhancers, taste enhancers, medically effective agents, or the like.

### FIELD OF THE INVENTION

The present invention is directed to a consumable food product comprised of a substantial portion of vegetable or fruit fibrous pulp as well as a process and method for the manufacture of same.

### DESCRIPTION OF THE PRIOR ART

It is recommended by numerous worldwide agencies, including the United States Department of Agriculture, that individuals consume a prescribed recommended daily intake of certain vitamins and minerals as part of an individual's diet. It is well recognized that numerous recommended nutrients can be obtained through the consumption of fruits and vegetables. For example, the beta-carotene obtained through the consumption of carrots is metabolized into vitamin A by the human body, a vitamin that is required for both scotopic and color vision as well as cell growth. Oranges, grapefruits, figs, Brussels sprouts, and kale are abundant sources of vitamin C, an essential antioxidant for the relief of oxidative stress. Dietary minerals (i.e., chemical elements required by living organisms other than the four elements carbon, hydrogen, nitrogen, and oxygen present in common organic molecules) such as potassium, a systemic electrolyte, are obtained through the ingestion of legumes, potato skin, tomatoes, and bananas.

In order to supply the body with these required nutrients, in addition to the raw-food and cooked consumption of fruits and vegetables, various mediums are available for the public consumption of these fruits and vegetables. Each of these processing methods exhibits certain traits and abilities to maintain the nutritive value of the base fruit and vegetable.

For example, dried food products are a well-recognized food medium capable of supplying a body with vitamins and minerals from fruits and vegetables. Conventional dried fruit products such as dried raisins, dates, plums, figs, apricots, peaches, apples, and pears (among others) are prized for their nutritive value in unsweetened form, appeasing taste, and most importantly their ability to resist to spoilage, thereby exhibiting a long commercial shelf life. Such fruit products, generally absent the addition of a sucrose syrup or other infused sweetener, are revered by world-health agencies, health-conscious individuals, and raw-food advocates as the dried food products typically retain a substantial portion of the nutritional value of the raw fruit or vegetable.

Similarly, fruit juice, vegetable juice, or blended fruit and vegetable juices are a popular food medium for supplying the recommended vitamins and minerals. Juice is typically prepared by mechanically squeezing or macerating fresh fruit or vegetable flesh without the application of heat or solvents. For example, orange juice is simply the liquid extract of the fruit of the orange tree.

The extraction of liquid to create juices from food products, such as fruits and vegetables, typically yields fibrous pulp or pulp byproduct. Mechanical liquid extraction apparatus are designed to extract the maximum liquid and yield a dry byproduct, and generally fall into three primary categories. The first type of extractor is a centrifugal extractor, which uses blades and a sieve to separate juice from pulp. A second type of extractor, masticating extractors, crushes and kneads fruit to a pulp, thereby forceably removing juice to leave a dry byproduct. The third type of extractor, commonly referred to as a triturating extractor, utilizes a series of gears to first crush a fruit or vegetable, and then press the crushed fruit or vegetable. Such extractors typically include a holding chamber for the fruit/vegetable to remove the liquid, which is then collected in a separate chamber.

A typical mechanical extractor apparatus is exemplified in Janovtchik U.S. Pat. No. 4,095,517, however it is well known in the art numerous alternative apparatus are readily available.

Once juice is extracted by any means of extraction, the byproduct remains include items such as seeds, rind, and pulp. The byproduct is generally discarded as waste, but in some instances the byproducts can be re-manufactured and reused. Products typically created using extract byproduct include dehydrated feed for livestock or domesticated animals, pectin, subject to elaborate processing and heating, for use in making jellies, citric acid, essential oils, molasses, and candied peel.

As one example, after extracting juice from a citrus fruit, an initial screening separates the layer materials (peels, seeds, pulp, etc.) from the juice. The layer materials are dried and utilized as livestock feed or further refined through an elaborate process to provide purified pectin for use in jams and jellies. In addition, common industrial uses are prevalent as certain fractions of orange oil have excellent solvent properties and are sold for use in industrial solvents and cleaners.

The layer materials, including pulp, can be utilized in other products as additives or bulking agents or in certain recipes to increase the dietary fiber of the ultimate food product.

The United States Patent and Trademark Office is replete with examples of use of fruit pulp as part of a variety of food products. For example, Staub et al. U.S. Pat. No. 4,379,782 is directed to a low-caloric food product formulated with a high level of polysaccharide and/or polyol components and increased fiber as a treatment for gastrointestinal ailments. The Staub et al. reference discloses that the preferred dietary fiber compositions are achieved by incorporating soy fiber concentrate, citrus albedo, pineapple core bulking agent and sugar beet pulp bulking agent as part of the resulting food product.

In another example, Loader U.S. Pat. No. 4,413,017 discloses a “food product containing juice pulp and acidified milk components.” The Loader food composition is primarily derived from the juice vesicles, a portion of the pulp more commonly referred to as the “finisher pulp,” which are the membranes which form the juice sacs. The Loader parent patent discloses “wet” food compositions employing a substantial portion of fruit pulp which is hydrated (and in certain instances substantially chilled or frozen) which exhibits a fluid viscosity and texture similar to pudding, (i.e., a viscosity ranging between about 7,000 to 18,000 c.p. at 40.degree . . . +−0.2.degree. F.) designed to be ingested as a “fruity” snack or dessert composition. The food products disclosed essentially comprise, (A) from about 30% to 55% by weight of raw, washed juice pulp (wet basis); (B) from about 5% to 15% of an acidified milk product such as sour cream or yogurt (solids basis); (C) from about 5% to 15% of nutritive carbohydrate sweetening agent(s); (D) sufficient edible organic acid to provide the food composition with a pH ranging from about 3.0 to 4.5; and (E) sufficient water to provide a moisture content of about 65% to 85%. Preferred embodiments as disclosed by Loader additionally comprise from about 5% to 20% fruit.

In yet another example, Beale et al. U.S. Pat. No. 4,451,489 discloses a process for producing a non-caloric sugar beet pulp bulking agent primarily designed as a low-caloric substitute ingredient for baked goods. The bulking agent is produced by placing sugar beet pulp slices, particles or spent cossettes into a stabilizing solution. The solution is washed in order to remove a majority of the soluble carbohydrates and an alcohol-based solution is introduced to remove the color and bitter constituents. The resulting solution is dried and milled to a flour consistency. The Beale et al. disclosure alleges that the sugar beet pulp bulking agent is useful as a partial replacement for high-caloric ingredients such as flour, fat and/or sugar in a food product with at least a one-third reduction in caloric density.

In another example, U.S. Pat. No. 6,063,429 to Stinson, Jr., et al. discloses a method for making a food product for human consumption which is composed of pulp and sweetening additives, such as glucose, sucrose, corn syrup and fructose. The food product is heated and scaled to produce a granular pudding-like texture which is eaten in that contemporaneous current state, mixed with other food products, or further dehydrated to create a fruit snack.

In light of the references recited above, it is apparent in the art that there exists a need to supply the body with required nutrients, including taking advantage of juice extraction by-product, which has inherent food value and is often unnecessarily discarded due to the absence in the art of a proper method to utilize the by products. In addition, there exists a need in the art to solve this problem in a way that takes advantage of the inherent benefits of providing fruit/vegetable product in its raw form, thereby maximizing the nutrients being supplied to the body. Specifically, there remains a need in the art for a food product composed nearly entirely of pulp. While several examples of use of the pulp byproduct are presented herein and known in the art, most, if not all of these examples are inadequate due to requiring the resulting product to be subjected to significant processing, including processing at high heat. Such high-heat processing results in substantial degradation of the inherent nutrients such as the vitamins, minerals, fiber, and other food chemicals known as photonutrients.

Thus, it is clear that there further remains a need in the art for a pulp food product that is produced with a substantially simple process and produced in a manner that preserves the nutrients and vitamins contained in the pulp.

### SUMMARY OF THE INVENTION

In view of the foregoing disadvantages inherent in the known uses for food product pulp, in accordance with a first preferred embodiment of the present invention, provided is a food product composed substantially entirely of pulp (i.e., a mass of fruit and/or vegetable matter, including residue, from which most of the water has been extracted) wherein the food product is produced in a manner that preserves the nutrients and vitamins contained naturally therein. A pulp food product, process and method of manufacturing same is provided comprising at least one pulp material formed from at least one raw vegetable or fruit wherein juice is substantially removed therefrom leaving behind the pulp material. In the preferred example, the pulp material is dried to contain no more than about 5% moisture after treatment by way of dehydration or freeze drying. The pulp food product comprises a base vegetable (or fruit) present in an amount ranging from about 55-100% by weight, a color vegetable (or fruit) present in an amount ranging from about 0-20% by weight, a flavor vegetable and/or fruit present in an amount ranging from about 0-20% by weight, and additional flavor ingredients present in an amount ranging from about 0-5% by weight. The process provides for processing raw fruits and/or vegetables through any known extractor to substantially separate juice and byproduct (hereinafter referred to as pulp), mixing the pulp, shaping the pulp into shaped structures, including, but not limited to granules, chips, sticks, etc., and drying the shaped pulp to no more than 5% by weight of moisture. The pulp food product composition can further include flavor enhancers, taste enhancers or medically effective agents, added in such a way to maximize retention of the pulp's essential nutrients.

In one embodiment, the pulp food product comprises at least one byproduct material formed from at least one raw vegetable and/or fruit wherein juice is substantially removed therefrom. The process of substantially removing the juice results in the creation of pulp material containing no more than approximately 5% moisture after treatment. While any of series of known binding agents may be incorporated into the mixture, it is preferred that a natural food binding agent such as arrowroot powder, guar gum, or xanthan gum is optionally added in order to maximize the nutrients retained by the pulp. The binding agent preferably comprises 10-25 g of binder/kilogram of pulp. Of course, one of ordinary skill in the art will readily recognize that in producing a natural food product of high nutrient value, using a low percentage of binder agent is more advantageous and as a result, optimal binder agent utilized in the formulation is approximately 14-16 g of binder/kilogram of pulp. Dietary supplements, vitamins, minerals, joint supplements, medicinal components, herbs, natural or artificial flavorings, and/or colorings can be optionally added to the pulp food product.

In another embodiment of the present invention, the pulp food product comprises a base vegetable pulp present in an amount ranging from about 40-100% by weight of the composition. The base vegetable pulp is preferably produced by extracting the liquid from one or more vegetables selected from the group consisting of kale, carrot, chicory, chard, collards, escarole, lettuce, spinach, flax seeds, sesame seeds, though one of ordinary skill in the art will readily recognize suitable alternative base vegetables. In the embodiment described in this example, 40-80% by weight of the base vegetable pulp preferably comprises green leafy vegetables, 0-50% by weight comprises pulp created by extracting juice from carrots, and 0-25% by weight comprises seeds. The food product described in this example preferably further comprises a color vegetable pulp present in an amount ranging from about 0-20% weight percent of the composition and preferably comprises flavor vegetable and/or fruit pulp present in an amount ranging from about 0-20% weight percent of the composition. Additional flavor ingredients making-up 0-5% by weight percent of the food product may be added.

In yet another embodiment of the present invention, a pulp food product is provided comprising a base vegetable pulp, present in an amount ranging from about 55-100% by weight of the composition, a color vegetable pulp ranging from about 0-20% by weight, a flavor vegetable and/or fruit pulp ranging from about 0-20% by weight, and additional flavor ingredients ranging from about 0-5% by weight. Preferably, 40-80% by weight of the base vegetable pulp comprises green leafy vegetables, 0-50% by weight comprises pulp created by extracting juice from carrots, and 0-25% by weight comprises seeds. Base vegetable pulp of the presently described composition may be formed by extracting juice from one or more vegetables selected from the group consisting of kale, carrot, chicory, chard, collards, escarole, lettuce, spinach, flax seeds, or sesame seeds, though one of ordinary skill in the art will be able to recognize suitable alternative base vegetables.

The pulp food product as described in the above examples is then molded into a plurality of desirable shapes designed to aid and encourage consumption. For example, the food product can be formed as a chip-like structure, disc structure, arcuate structure, parallelogram structure, or any geometric shape. A plethora of other shapes may be utilized in forming the pulp food product, including flora or fauna shapes, or shapes in the form of recognized characters. Alternatively, the pulp food product can be provided as granules to be utilized in other products such as a food topping or seasoning or additive to a liquid such as water to provide a flavored drink. The pulp food product can also optionally include a flavored, textured, and/or color coating.

Further, a simplified method of making the aforementioned variations of the pulp food product is herein disclosed, resulting in the retention of the high nutritive value of the underlying ingredients. The method includes the steps of: (i) processing raw fruits and/or vegetables through an extractor to substantially separate juice and pulp; (ii) mixing the pulp; (iii) shaping the pulp into structures; and (iv) drying the shaped pulp to no more than 5% by weight of moisture. The method may further comprise the step of adding a binding agent, dietary supplements, joint supplements, herbs, natural or artificial flavorings, vitamins, medicaments and/or minerals. Drying is preferably lyophilization (freeze-drying) or dehydration. The shaped pulp is preferably dried to contain no more than 5% moisture, to limit the need for an added preservative. Drying is performed at a temperature of no higher than 118 degrees Fahrenheit in order to preserve the nutrients and vitamins contained in the pulp. The method may further include a coating step.

Accordingly, it is an object of the present invention to provide food products of high nutritional value, primarily composed of natural fruit and/or vegetable pulp, a common byproduct of juicing operations which is typically an underutilized and often discarded byproduct.

It is a further object of the present invention to provide food products exhibiting a high dietary fiber content.

Another object of the present invention is to provide food products of reduced ingredient cost and reduced production cost which are the primary result of minimal processing.

Still another object of the present invention is to provide a method of manufacturing food products which is minimally intrusive to the vitamins and minerals of the base food pulp which results in zero or minimal degradation of the nutrient content resulting in highly nutritious food products.

A further object of the present invention is to provide a food product of appeasing taste, color, texture, and shape which provide high satiety upon consumption to encourage the consumption of the nutritional food product.

It is still a further objective of the present invention to provide a food product of substantial shelf-life which is of durable and reliable composition.

Another objective of the present invention is to provide a new and improved method for preparing food products of a natural composition which is easily and efficiently manufactured, packaged, and marketed.

It is another objective of the present invention to provide food products which exhibit a relatively low cost of manufacture in regard to both materials and labor which can provide an economical solution to providing natural and nutritious food products to the consuming public.

Thus, there has been summarized and outlined, generally in broad form, a plurality of the most important features of the present invention, as described with respect to the foregoing preferred and alternate embodiments, in order that the following detailed description thereof which follows may be better understood by one of ordinary skill in the art. This summary and outline is further presented so that the novelty of the present contribution to the related art may be better appreciated. It will further be apparent that additional features of the invention described hereinafter and which will form the subject matter of the claims appended hereto will further define the scope, novelty, and in certain instances the improvements upon any existing art.

Further, it is to be readily understood that the invention presented herein is not limited in its application to the details of construction and to the arrangements of the components set forth in the following description or illustrated in the various figures integrated and categorized herein. The scope of the disclosure is presented in broad form so that other objects, features, and characteristics of the present invention, and the combination of parts and economies of manufacture, will become more apparent upon consideration of the following detailed description.

Those skilled in the art will appreciate that the disclosure of the present invention may readily be utilized as a basis for the designing of other similar structures, methods and systems for carrying out the various purposes and objectives of the present invention. Thus, the claims as set forth shall allow for such equivalent constructions insofar as they do not depart from the spirit and scope of the present invention as described herein.

### BRIEF DESCRIPTION OF THE DRAWINGS

A further understanding of the present invention and the objectives other than those set forth above can be obtained by reference to the various embodiments set forth in the illustrations of the accompanying figures. Although the illustrated embodiment is merely exemplary of the present invention, both the construction of the invention and the resulting food product, in general, together with further objectives and advantages thereof, may be more easily understood by reference to the drawings, examples, and the following description. The tables, examples, and figures are not intended to limit the scope of this invention, which is set forth with particularity in the claims as appended or as subsequently amended, but merely to clarify and exemplify the invention. The detailed description makes reference to the accompanying figures wherein:

FIG. 1 is a flow chart showing the method of manufacture of the pulp food product; and

FIG. 2 illustrates a front perspective view of the pulp food product shaped as a series of chips and sticks co-mingled and distributed in a singular packaging comprising sealed bag and viewing window.

### DETAILED DESCRIPTION OF THE PREFERRED EMBODIMENT

A detailed illustrative embodiment of the present invention is disclosed herein. However, techniques of manufacture and resulting structures in accordance with the present invention may be embodied in a wide variety of forms and modes, some of which may be quite different from those in the disclosed embodiment. Consequently, the specific structural details disclosed herein are merely representative, yet in that regard, they are deemed to afford the best embodiment for purposes of disclosure and to provide a basis for the claims herein which define the scope of the present invention. The following presents a detailed description of several examples of the present invention.

Moreover, well known methods, procedures, and substances for both carrying out the objectives of the present invention and illustrating the preferred embodiment are incorporated herein but have not been described in detail as not to unnecessarily obscure novel aspects of the present invention.

The pulp food product of the subject invention is a novel product providing a healthy treat and/or snack for consumers. The pulp food product, process and method herein provides the ability to utilize the left-over nutrient-rich pulp that results as a byproduct from juicing one or more fruits, vegetables, seeds, tubers, and other suitable natural foods to form a food treat or snack that is healthy for both people and pets. After the juice is extracted from the raw material, fruit, vegetable, tuber, or combinations thereof, the nutrient fiber rich pulp (consisting of soluble and insoluble fiber, each possessing unique health benefits) is treated, freeze dried, or dehydrated by other means in order to provide a food product that retains the nutrients, vitamins, and fiber in the pulp. The pulp-based food product is not only nutrient rich, but is very low in calories. In addition, the minimally-processed resulting product is appeasing to the palate and provides a healthy food for both people and pets. The provided pulp food product is completely natural and substantially calorie free. As produced, the pulp food product does not require the addition of oils or other preservatives while still providing a product of satisfying taste. Although the bulk food product is appeasing in taste, the method of manufacture disclosed herein still provides for the addition of various flavoring. Finally, the method of manufacture allows for the addition of other minerals, vitamins, herbs, medicaments, and/or supplements such as joint enhancing supplements for improved benefits which may or may not be evident in the base food product for even greater benefits.

Blend Preparation

Raw material, fruit, vegetables, tubers, or mixtures thereof, is first processed through a juice extractor. The juice is secured at temperatures below 40 degrees Fahrenheit for further processing. Once the juice is extracted, the remaining byproduct consists of fibrous pulp. The fibrous pulp is delivered in a temperature controlled manner for forming and drying. The fibrous pulp is mixed and optionally combined with a natural binding agent or other suitable binding agent as may be available at the time. Following mixing, the processed pulp is shaped into chip-like structures which may be any geometric shape, shaped representation of flora or fauna, known and marketable characters, or other desired shape. The shaping process may result in additional juice release. The shaped pulp is dried via lyophilization, dehydrating, or other such suitable method so that the finished product contains no more than 5% by weight moisture. It should be noted that this processing does not require subjecting the shaped pulp to high heat thereby maintaining the healthy nature of the product. All processing and handling is in accordance with applicable animal and human food handling guidelines.

Method of Preparation

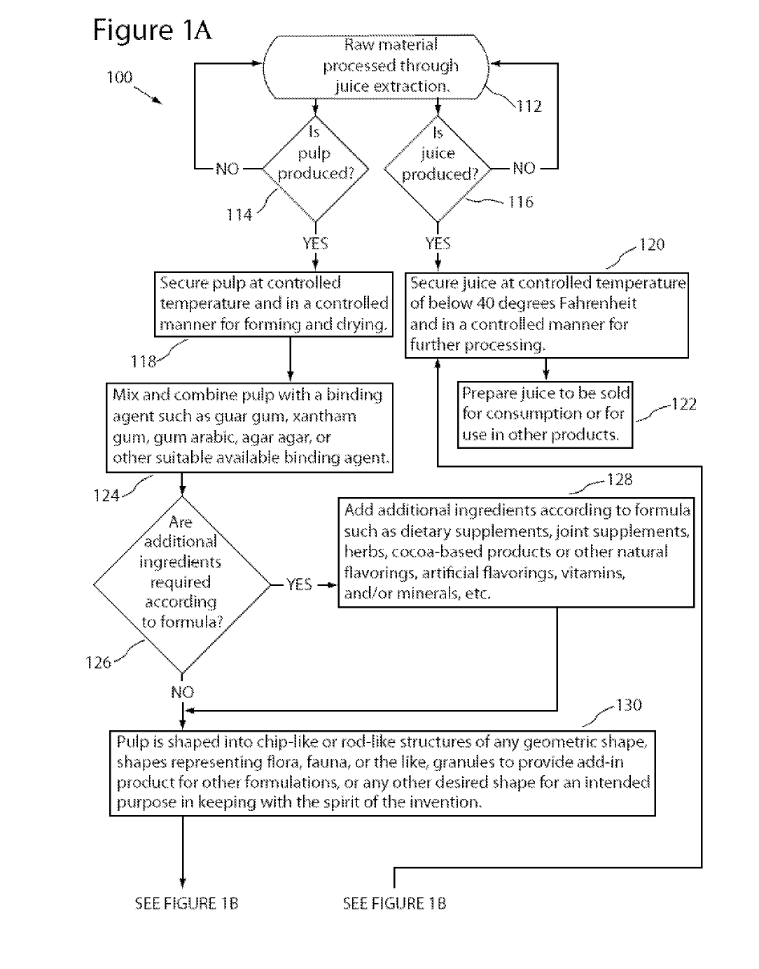

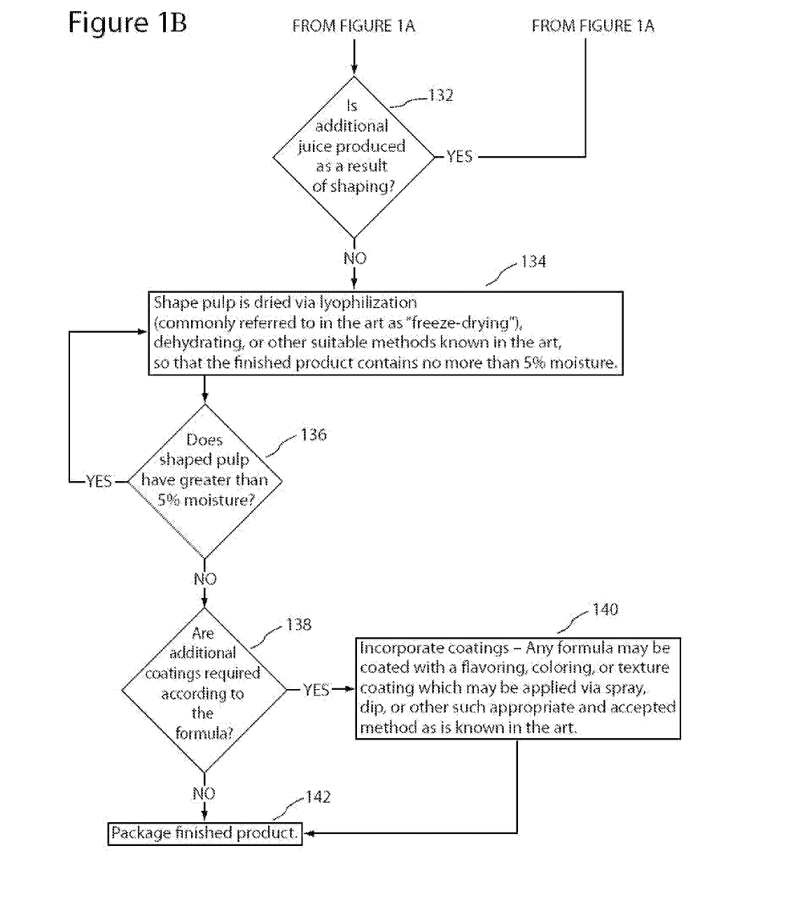

FIG. 1 illustrates a flow chart of the process for making the pulp food product, shown generally at 100. Raw material is first processed using a conventional juice extraction method at step 112. Raw food product comprising one or more fruits and/or vegetables is treated through extraction at step 112 to remove substantial amounts of the liquid. In the event juice is produced at conditional step 116 as a result of step 112, resulting juice is secured at temperatures below 40 degrees Fahrenheit for further processing at step 112. Further processing of juice at step 120 includes the preparation of juice for consumption or for use in a myriad of other products signified in step 122. In the event pulp is produced at conditional step 114 as a result of step 112, resulting fibrous pulp is delivered in a temperature controlled manner for forming and drying at step 118. Specifically, the preferred embodiment of the present invention requires a preferred temperature under 40 degrees Fahrenheit as prescribed by current proper food handling guidelines. Step 112 is continued until all raw material is processed and conditional steps 114 and 116 are satisfied, yielding pulp and/or juice. The fibrous pulp is mixed and may be combined with a binding agent such as guar gum, xanthan gum, gum arabic, agar agar, or other suitable binding agent as may be available at the time as shown at step 124. Optimal binder of the formulation is about 14-16 g of binder per kilogram of pulp. In the event additional ingredients are required according to the prescribed formula at conditional step 126, additional ingredients can be added, including, but not limited to, dietary supplements, joint supplements, herbs, natural or artificial flavorings, vitamins, and/or minerals at step 128 and the mixture is returned to the processing until no additional ingredients are required according to the prescribed formula.

Following the mixing of steps 124 and 128, the processed fibrous pulp is molded into chip-like structures which may be any geometric shape, shaped representation of flora or fauna, shaped representation of a known character, or other desired shape at step 130. Depending on the specific pulp utilized, the product consistency can be regulated to achieve the desired level of chewy or crunchy chip to provide for a chip which is appeasing to the palate. In the event that the shaping process results in additional juice release, conditional step 132 directs the reversion of the resulting juice step 120 allowing for the securing of the juice in a controlled manner and at a controlled temperature of below 40 degrees Fahrenheit for further processing. This additional juice may be recirculated for further processing as is widely known in the art. The shaped fibrous pulp is dried via lyophilization, dehydrating, or other such suitable method known in the art so that the finished product contains no more than 5% moisture at step 134. Drying continues until the shaped pulp yield has less than 5% moisture by weight as prescribed by conditional step 136. When utilizing a dehydration process, the dehydration process is conducted at very-low temperature, preferably at a temperature of no greater than 118 degrees Fahrenheit, in order to maintain the nutrient levels as it is well known in the art that higher temperatures tend to degrade nutrient levels of the vegetable or fruit. This low-temperature dehydrating process not only maintains the nutritive quality of the base food but also maintains the taste of base food thereby mitigating the need to incorporate additional flavorings or sugars to make a more palatable treat. While the temperature of 118 degrees Fahrenheit is preferred according to certain standards known in the art, one of ordinary skill in the art will readily recognize that historically such standards have been known to change from time-to-time and are dependent on the raw material utilized. Therefore, it is well recognized that in the event new studies yield new information, the present drying method referenced herein may be modified to account for such standards without departing form the spirit and intent of the present invention. In addition to the drying, it is contemplated by the present invention that in certain instances additional “cooking methods” such as baking or frying the pressed pulp chip may be performed. In the event additional coatings are required in accordance with the prescribed formula according to conditional step 138, a coating, such as flavoring, coloring, or texture coating (e.g., a gelatin) may be applied via spray, dip, or other such appropriate and accepted method as is known in the art at step 140. Once coated, or un-coated according to the parameters of conditional step 138, the pulp food product is packaged at step 142 for transportation, storage, and ultimately for consumption of the food product.

All processing and handling is in accordance with applicable animal and human food handling guidelines. It is preferred that any resulting juice is further processed and utilized. The juice may be utilized to form ice juice cubes, frozen pops, or dried to form an add-in powdered substance. It is contemplated by the present invention that the juice in dried form can be utilized to or to season a food by adding the pulp alone for vitamin supplement. The pulp and/or juice may be made as a spread to enhance flavor and add nutritional benefits.

The process of the present invention may be utilized to produce a pulp that is granulated to form an add-in powder substance formed as an add-in to mix with bottled water/ice cubes or the like. It has been found that prolonged storage of vitamins and/or mineral supplement containing bottled water results in reduction in potency of vitamins and/or minerals as well taste and flavor deterioration. Preservation of taste and flavor requires addition of chemicals to the packaging or the bottled water, which may not be of nutrition value and in fact may harm the user in the long run. It is therefore advantageous to add the presently disclosed invention, in granulated form, to bottled water just before consumption (e.g., distribution from a peel away package). This assures that vitamin and/or mineral nutrients have full potency; that medically effective supplements are free from chemical reaction products; and that flavor and taste enhancing supplements provide expected flavor and taste. In addition, the user may select more than one peel away package to create a custom bottled water beverage according to taste preferences. The key requirement for the proper functioning of peel away packages is that the ingredients contained therein are free flowing and dissolve readily. In the case of powders, the dissolution rate of powder material is function of its composition and its particle size. While the composition is preselected, it is generally not a variable, but the particle size of the powder can be controlled by the manufacturing process of the peel away packages. Consider a volume of V centimeter cube of a powder with an average particle size of d microns. N is the number of particles needed to fill the space of V cubic centimeters. The following equation shows the relationship between V, d and N.

$$V = N ( \frac{4}{3} Π \frac{{d}^{3}}{8} )$$

The surface area S of the N particles of diameter d is given by the equation:

$$S = N Π {d}^{2} = \frac{6 V}{Π d}$$

Therefore decreasing the particle size from 100 mesh (140 microns diameter) to 325 mesh (44 micron diameter) results in a surface area increase of 140/44 or 3.18. If the particle size were reduced to 5 microns, the surface area will increase by 140/5 or 28 times. The finer sized particles typically are free flowing.

When liquid or semi-solid ingredients are to be contained in the peel away package they should to be encapsulated, preferably microencapsulated in a gelatin capsule. The gelatin capsules dissolve away releasing the peel away package content to the bottled water. Capsules contained within the peel away package are free flowing. The propensity of gelatin capsules to promote a free flowing particle characteristic followed by rapid dissolution in water makes gelatin the preferred encapsulant. Ingredients in the peel away packages may include vitamins, minerals, taste enhancers, flavoring agents, medically effective agents and the like.

Typical vitamins in powder form includes vitamin C, B1, B2, B6, B12, folic acid coenzyme (CQ10) and D. Typical liquid or semi-solid vitamins include vitamin A and E. Minerals in powder form include calcium compounds, preferably calcium citrate, magnesium compound, preferably magnesium citrate, chromium compound, preferably chromium picolinate or Niacin chromium GTF complex, zinc compound, selenium compound, iron compounds and others. Antioxidants include coenzymes. Hydrating substances include sodium and potassium chloride. Medically effective agents may include aspirin, and other over the counter medications in proper dosages. Flavors may include orange flavor, lemon or lime flavor, guava flavor, mango flavor, dragon fruit flavor, green tea, caffeine of guarana.

One medically effective agent which is particularly advantageous comprises gum Arabic powder. Gum Arabic is a natural product, occurring as an exudate from the trunks and branches of the Acacia Senegal tree. Gum Arabic powder is water soluble. A six ounce dosage is sufficient to support an adult for twenty-four hours. In some cases of disease, it is considered that a solution of Gum Arabic may for a time constitute the exclusive drink and food of the patient.

### Example Compositions

In a first embodiment, the pulp food product comprises at least one pulp material formed from at least one raw vegetable and/or fruit wherein juice is substantially removed therefrom. The process of substantially removing the juice results in the creation of pulp material containing no more than approximately 5% moisture after treatment. The resulting food pulp is one hundred percent natural raw food and is generally low in fat and salt, yet is high in fiber, vitamins, minerals, antioxidants, and other photonutrients. While any of series of known binding agents may be incorporated into the mixture, it is preferred that a natural food binding agent such as arrowroot powder or xanthan gum is optionally added. The binding agent preferably comprises 10-25 g of binder/kilogram of pulp. Of course, one of ordinary skill in the art will readily recognize that in producing a natural food product of high nutrient value, using of a low percentage of binder agent is more advantageous and as a result, optimal binder agent utilized in the formulation is approximately 14-16 g of binder/kilogram of pulp. Dietary supplements, vitamins, minerals, joint supplements, medicinal components, herbs, natural or artificial flavorings, and/or colorings can be optionally added to the pulp food product.

In a second embodiment, the pulp food product comprises a base vegetable pulp present in an amount ranging from about 40-100% by weight of the composition. The base vegetable is preferably selected from the group consisting of kale, carrot, chicory, chard, collards, escarole, lettuce, spinach, flax seeds, sesame seeds, and/or combinations thereof. In this example, 40-80% by weight of the base vegetable pulp preferably comprises green leafy vegetables, 0-50% by weight comprises pulp created from extracting juice from carrots, and 0-25% by weight comprises seeds. This pulp food product preferably further comprises a color vegetable pulp present in an amount ranging from about 0-20% weight percent of the composition and preferably comprises flavor vegetable and/or fruit pulp present in an amount ranging from about 0-20% weight percent of the composition. Additional flavor ingredients making-up 0-5% by weight percent of the pulp food product may be added.

In a third embodiment, a pulp food product is provided comprising a base vegetable pulp, present in an amount ranging from about 55-100% by weight of the composition, a color vegetable pulp ranging from about 0-20% by weight, a flavor vegetable and/or fruit pulp ranging from about 0-20% by weight, and additional flavor ingredients ranging from about 0-5% by weight. Preferably, 40-80% by weight of the base vegetable pulp comprises green leafy vegetables, 0-50% by weight comprises pulp created by extracting the juice from carrots, and 0-25% by weight comprises seeds. Base vegetable pulp of the composition may be created from kale, carrot, chicory, chard, collards, escarole, lettuce, spinach, flax seeds, sesame seeds, and/or combinations thereof.

Table I below sets forth formulations with weight percents utilized in making the pulp food product:

TABLE I

| | Pulp | Weight |
|---|---|---|
| Formulation | material | percent |
| 1 | Carrot | 45% |
| | Kale | 32% |
| | Broccoli | 20% |
| | Ginger | 3% |
| 2 | Chard | 40% |
| | Carrot | 30% |
| | Pepper | 3% |
| | Garlic | 3% |
| | collard | 24% |
| | Greens | |
| 3 | Kale | 20% |
| | Carrot | 40% |
| | Chicory | 20% |
| | Onion | 9% |
| | Cilantro | 10% |
| | Jalapeno | 1% |
| 4 | Carrot | 30% |
| | Chicory | 30% |
| | Sesame seed | 30% |
| | Ginger | 4% |
| | Lime | 4% |
| | Soy sauce | 2% |

Table II below sets forth formulation combinations that may be utilized in making the pulp food product:

TABLE II
Formulations

Carrot, kale, broccoli, ginger
Cucumber, broccoli, lemon
Beet, cucumber, chard, celery
Carrot, kale, garlic, apple
Kale, chard, broccoli, garlic, ginger, apple
Kale, beet, carrot, pepper, spinach
Sprouts, garlic, beet, chard
Chard, carrot, pepper, garlic, collard greens
Cabbage, carrot, ginger, kale
Leek, kale, spinach, beet, carrot
Parsley, kale, chard, carrot, ginger
Cilantro, kale, carrot, pepper, garlic
Carrot, kale, broccoli, ginger
Cucumber, broccoli, lemon
Beet, cucumber, chard, celery
Carrot, kale, garlic, apple
Kale, chard, broccoli, garlic, ginger, apple
Kale, beet, carrot, pepper, spinach
Sprouts, garlic, beet, chard
Chard, carrot, pepper, garlic, collard greens
Cabbage, carrot, ginger, kale
Leek, kale, spinach, beet carrot
Parsley, kale, chard, carrot, ginger
Cilantro, kale, carrot, pepper, garlic
Kale carrot, chicory, tomato, basil, onion
Kale, chicory, carrot, apple, cinnamon
Kale, carrot, chicory, onion, cilantro, jalapeno
Carrot, kale, cilantro, chicory, chili, lime,
onion, garlic
Carrot, chicory, kale, ginger, lime, chili
Kale, carrot, chicory, tomato, basil, onion
Kale, chicory, carrot, apple, cinnamon
Kale, carrot, chicory, onion, cilantro, jalapeno
Carrot, kale, cilantro, chicory, chili, lime,
onion, garlic
Carrot, chicory, kale, ginger, lime, chili

Table III below sets forth weight percent categories in formulating the pulp food product:

TABLE III

| | | Wt % Flavor | |
|---|---|---|---|
| Wt % Base | Wt % Color | Vegetables & | Wt % Other |
| Vegetables | Vegetables | Fruits | Flavor |
| 55-100% | 0-20% | 0-20% | 0-5% |
| Examples: | Examples: | Examples: | Examples: |
| Kale, carrot, | Pepper | Tomato, | Herbs, spices, |
| chicory, | (yellow, | onion, | and natural |
| chard, | red, | garlic, | flavorings |
| collards, | orange), | ginger, | like soy |
| escarole, | beet, squash | peppers, | sauce, chicken |
| lettuce, | | lemon, lime, | broth, chicken |
| spinach, flax | | apple, pear, | base, cinnamon |
| seeds, sesame | | cilantro, | powder, chili |
| seeds | | parsley, | powder, etc |
| | | dill | |

As indicated in Table III above, base vegetables make-up about 55-100% of the pulp food product. The base vegetable pulp provides structure, consistency, mouth feel, and foundation color. Examples include kale, carrot, chicory, chard, collards, escarole, lettuce, spinach, flax seeds, sesame seeds, and/or combinations thereof. Of the 55-100% by weight of base vegetables, about 40-80% by weight comprise green leafy vegetable pulp, 0-50% by weight comprise carrot pulp, and 0-25% by weight comprise seeds.

Color vegetable pulp preferably makes up about 0-20% of the pulp food product formulation. Examples include pepper (yellow, red, orange), beet, and squash.

Flavor vegetable and fruit pulp preferably makes up about 0-20% of the pulp food product formulation. Examples include tomato, onion, garlic, ginger, peppers, lemon, lime, apple, pear, cilantro, parsley, dill.

Other flavor ingredients may be added, preferably making-up about 0-5% of the pulp food product formulation. Examples include herbs, spices, and natural flavorings like soy sauce, chicken broth, chicken base, cinnamon powder, chili powder, etc. Ingredients can be easily added for flavor, chicken broth, beef broth, fish oil (containing high levels of omega-3), plus glucosamine chondroitin and MSM . . . or potent, digestive-friendly probiotics, etc.

Additional ingredients may be added to the pulp food product. These may include: dietary supplements, herbs, flavorings (natural or artificial), vitamins, minerals, joint supplements. Joint enhancing supplements, medicaments, pheramone additives for better emotional and mental balance, may be added to the formulation. Such joint enhancing and rebuilding compositions can be found in U.S. Patent Application Publication No. 2008/0069862, hereby incorporated by reference. The publication discloses a pet supplement including a joint preserving and joint rebuilding composition comprising chicken collagen type II, glucosamine hydrochloride and chondroitin sulfate, a vitamin composition comprising vitamins C, D and K, a mineral composition comprising calcium, magnesium, zinc, copper, manganese and boron, a herbal antioxidant cofactor blend comprising citrus bioflavonoids, red grapes anthocyanins, turmeric rhizome, boswellia resin and fennel seed. Each of the ingredients is intimately mixed into the pet supplement and orally delivered to the pet in the form of a segment, paste or powder having a size and weight or other dosage measuring feature adjusted in accordance with the pet's weight. A synergistic action between these ingredients preserves and rebuilds the pet's joints, and is nutritionally beneficial for the pet.

As previously referenced, the pulp food product of the defined examples is shaped into a plurality a desirable shapes designed to aid and encourage consumption. For example, the food product can be formed as a chip-like structure, disc structure, arcuate structure, parallelogram structure, or any geometric shape. A plethora of other shapes may be utilized in forming the pulp food product, including flora or fauna shapes. Alternatively, the pulp food product can be provided as granules to be utilized in other products such as a food topping or seasoning or additive to a liquid such as water to provide a flavored drink. The pulp food product can also include a flavored, textured, and/or color coating.

Coatings may be applied to provide a flavor, color, and/or texture. The coating may be applied via spray, dip, or other such appropriate and accepted method. The coating may be an edible film, gelatin, or other edible coating. Spray coating of baked products with an oleaginous or hydrophobic composition is disclosed in U.S. Pat. Nos. 5,130,150, 4,960,600, 4,038,422, and 3,484,250 which are incorporated herein by reference.

Dispensing of pressurized oil-based compositions from a pressurized container onto a food product is disclosed in U.S. Pat. Nos. 4,801,465 and 2,844,469. Supercritical fluid or high pressure gas as a spray medium or carriers for food additives or food enhancers is disclosed in U.S. Pat. No. 5,520,942. Suitable food coatings such as these may be utilized to coat the pulp food product of the subject invention.

### Resulting Product

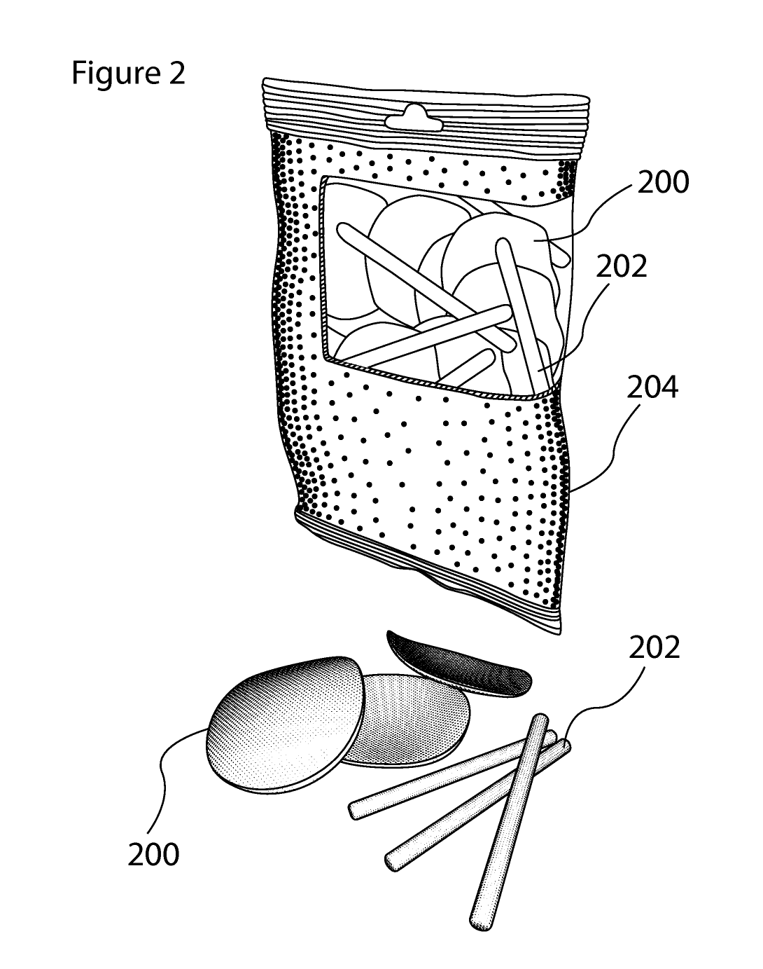

FIG. 2 illustrates a schematic view of the pulp food product shaped as a series of chips 200 and sticks 202 sealed in hermetically sealed packaging 204, Packaging 204 may be a bag, box container, or any other common packaging suitable for food products of this similar nature which resists adverse effect on the composition of the internal product and degradation of the nutrient of the product. Packaging 204 is generally comprised of a pouch sheet sealed on one end, filled, and sheet sealed on the opposing end. Packaging 204 can exhibit resealable properties and can also exhibit apertures for package display. Presently, a preferred perimetrical shape of the food product is generally oval, chip-like in two dimensions. Alternatively, other embodiments may include a perimetrical shape which is generally triangular, square, rectangular, or any other such geometric or fanciful shape as may be thought at the time to have consumer appeal or processing, handling, or packaging advantages.

What is claimed is:

1. A pulp food product comprising:
at least one pulp material formed from at least one raw vegetable or fruit wherein juice is substantially removed therefrom leaving behind said pulp material; and
a binding agent;
wherein said pulp material contains no more than approximately 5% moisture after treatment.

2. A pulp food product as recited by claim 1, wherein said binding agent is selected from the group consisting of guar gum, xanthan gum, agar agar, puma Arabic and other suitable binding agents.

3. A pulp food product as recited by claim 1, further comprising a supplement ingredient selected from the group consisting of dietary supplements, joint supplements, vitamins and minerals.

4. A pulp food product as recited by claim 1, further comprising an additive ingredient selected from the group consisting of herbs, natural or artificial flavorings, and colorings.

5. A pulp food product as recited by claim 1, wherein the shape of said pulp food product is selected from the group consisting of a chip-like structure, disc, arcuate structure, parallelogram, geometric shape, recognizable fictional character, flora or fauna.

6. A pulp food product as recited by claim 1, wherein said pulp food product is provided as granules and is appointed to be utilized in other products.

7. A pulp food product as recited by claim 1, wherein said pulp food product is provided as granules and is appointed to be utilized as a topping or seasoning on food products.

8. A pulp food product as recited by claim 1, further comprising a coating selected from the group consisting of flavor coating, color coating and texture coating.

9. A pulp food product as recited by claim 1, further comprising a color vegetable comprising about 0-20% weight percent of said pulp food product.

10. A pulp food product as recited by claim 1, further comprising one or more flavor ingredients selected from the group consisting of a plurality of vegetables, a plurality of fruits, or a plurality of vegetables and fruits, wherein said flavor ingredients comprise 0-20% weight percent of said pulp food product.

11. A pulp food product as recited by claim 1, further comprising additional flavor ingredients wherein said flavor ingredients comprise 0-5% weight percent of said pulp food product.

12. A pulp food product as recited by claim 1, wherein said pulp material comprises between about 40-100% by weight composition of said pulp food product.

13. A pulp food product as recited by claim 1, wherein said pulp material comprises between about 75-100% by weight composition of said pulp food product.

14. A pulp food product as recited by claim 1, wherein said pulp material is between about 90-100% by weight composition of said pulp food product.

15. A pulp food product comprising:
a base vegetable, having a weight percent of between about 55-100%
a color vegetable having a weight percent of about 0-20%;
a flavor vegetable and/or fruit having a weight percent of about 0-20%; and
additional flavor ingredients having a weight percent of about 0-5%.

16. A pulp food product as recited by claim 15, wherein 40-80% by weight of said base vegetables comprises green leafy vegetables, 0-50% comprises carrot, and 0-25% comprises seeds.

17. A pulp food product as recited by claim 15, wherein said base vegetable is selected from the group consisting of kale, carrot, chicory, chard, collards, escarole, lettuce, spinach, flax seeds, sesame seeds, or combinations thereof.

18. A method of making a pulp food product comprising the steps of;
processing raw fruits and/or vegetables through an extractor to substantially separate juice and pulp;
mixing said pulp;
shaping said pulp into structures; and
drying said shaped pulp to no more than 5% by weight of moisture.

19. A method of making a pulp food product as recited by claim 18, wherein said drying is by way of lyophilization dehydration.

20. A method of making a pulp food product as recited by claim 18, wherein said drying is performed at a temperature of no higher than 118 degrees Fahrenheit.
